(19) United States
(12) Patent Application Publication
(10) Pub. No.: US 2002/0056988 A1
(43) Pub. Date: May 16, 2002

(54) Method for printing and verifying limited edition stamps

(76) Inventor: David L. Patton, Webster, NY (US)

Correspondence Address: Milton S. Sales, Patent Legal Staff, Eastman Kodak Company, 343 State Street, Rochester, NY, 14650-2201, US

(21) Appl. No.: 09/903,346

(22) Filed: Jul. 11, 2001

Related U.S. Application Data
(62) Division of application No. 09/534,433, filed on Mar. 23, 2000.

(51) Int. Cl. G09F 3/00; B41J 11/44

(52) U.S. Cl. 283/71; 400/103; 400/76

(57) ABSTRACT

A limited edition stamp and method for printing limited edition stamps from a plurality of different printers and locations. The limited edition stamps each having a unique ID not visible under normal viewing conditions. The unique ID number is allocated to different printers by a single computer that is communication with all of the printers.

### FIELD OF THE INVENTION

This invention relates to the printing and verification of limited edition stamps.

### BACKGROUND OF THE INVENTION

To ensure the quality and authenticity of official United States postage stamps they are printed using a Gravure process. The Gravure process is capable of creating images of very high resolution, way beyond the capabilities of most common printers. The Gravure process is an intaglio process. It uses a depressed or sunken surface etched into a copper cylinder to create the image and the unetched surface of the cylinder representing non-printing areas. The cylinder rotates in a bath of ink and the etched area picks up the ink and transfers it to the media creating the image. Gravure printing is considered excellent for printing highly detailed marks or pictures. High cylinder making expense usually limits use of Gravure rollers to long printing runs. The Gravure process described for printing stamps does not lend itself to economically printing small batches of stamps in small quantities, for example, batches from about of 10 to 10,000. Nor does the Gravure process for printing stamps allow for each individual stamp to be differentiated from the stamp next to it in a sheet. As an example an artist can create an etching and print a limited number of copies. The artist than hand numbers each individual copy as 1/1,000, 2/1,000 and so forth. Consumers or collectors who buy the copies then know there are a limited number of copies and what number they have purchased. It would be very desirable in the eye of a stamp collector to be able to buy a sheet of stamps from a limited printing comprised of a block of individually numbered stamps each stamp marked with an individual number such as 1/10,000. The problem with the method that is currently used to produce stamps is it is not possible to economically print stamps with this number feature in small quantities. U.S. Pat. No. 5,120,089 describes a method for adding a distinguishing mark to a sheet of stamps after the stamps have been printed. The problem is the mark is added after the printing and is not part of the original stamp.

Digital printers such as KODAK PS 8650 Color Printer, or a KODAK Photo Printer 4700 are capable of printing stamps economically in small quantities, while meeting the same printing quality requirements previously met using the Gravure process. The advent of digital printing technology now allows the printing of stamps on demand in small quantities at remote locations. Digital printing technologies allow stamps to be printed from digital files stored on servers. The stamp image files can be downloaded to remote printing locations and printed on site in small quantities on demand. Commonly-assigned U.S. patent application Ser. No. 09/359,152, filed Jul. 22, 1999, entitled “Authorizing the Printing of Digital Images” by Patton et al describes a method for sending a digital image file to an authorizing agency. This reduces the time and cost required producing stamps. It also allows the USPO to offer larger number of choices of images from which the public can choose for a stamp. This is possible because the stamp image can exist as files and not as etchings on expensive Gravure cylinders. Commonly-assigned U.S. patent application Ser. No. 09/378,159, filed Aug. 19, 1999, entitled “System for Customizing and Ordering Personalised Postage Stamps” by Patton et al describes a method for selecting stamps from a digital image file located on a server at an authorizing agency. Using digital technology enables the USPO to offer the consumer a library of image from which to choose. The consumer is able to select what image they want printed as a stamp and how many they want from a library of stamp images stored on a server. A problem that arises with the printing of stamps from image files at remote post office locations is the increased possibility of having counterfeit stamps being printed at unauthorized locations.

U.S. Pat. No. 4,725,718 discloses using an encrypted message based upon the postage amount and the mail address as a method to insure authenticity of the postage. U.S. Pat. No. 4,831,555, discloses a postage applying system where the device used for printing of postage and the accounting unit are separated from one another by an unsecured link and the authenticity of the postage is insured by encryption. Both of these patents disclose printing of postage using a device such as an off-the-shelf printer. The postage is printed directly onto the envelope or onto a label, which is adhered to the envelope. The postage printed is akin to postage printed using a postage meter. When the postage is printed using an off-the-shelf printer and not a secured postage meter, an encryption scheme as described in the patents previously set forth is used. There are several problems with using off-the-shelf printers and the method described. The postage consists of a two-dimensional bar code and sometimes indicia. The indicia printed using this method are typically very rudimentary and are no more than line drawings. These printers do not have means for insuring that the quality and detail are properly maintained to meet the standards required of an official postage stamp. Also if a user or printer makes a mistake when printing the postage the value of the stamp may be lost or difficult for the consumer to obtain reimbursement.

When printing limited edition stamps that are individually numbered using a printer at a remote location, there is a problem of knowing what numbers have been previously used. For example if the USPO wanted to offer 10,000 stamps to be printed as a limited edition. The consumer can go into any U.S. Post Office and request a sheet of stamps until the 10,000 stamps have been printed. Each stamp on the sheet of stamps must be individually numbered with a unique number. How does each individual post office and each printer, when there is more than one printer, know what number have already been used to print stamps.

Another problem with the existing stamp printing process is that it is not easy or economical to be able to offer stamps for sale for a specific period of time. For example, the U.S. Post Office would like to offer a stamp that would be available to the consumer only from July 1 to September 30.

The present invention is directed to limited edition stamps and a method for producing them, which overcome the problems of the prior art.

### SUMMARY OF THE INVENTION

The above, and other objects, advantages and novel features of the present invention will become more apparent from the accompanying detailed description thereof when considered in conjunction with the following drawings.

In accordance with one aspect of the present invention there is provided a method of printing limited edition stamps from a plurality of different printers, the limited edition stamps each having a unique ID, comprising the steps of:

allocating a selected number of the unique IDs to one of the plurality of different printers; and

printing the selected number of limited edition stamps with the unique IDs at the one printer.

In accordance with another aspect of the present invention there is provided a method of printing limited edition stamps from a plurality of different locations, the limited edition stamps each having a unique ID, comprising the steps of:

allocating the unique IDs for a selected number of limited edition stamps to one location of the plurality of different locations; and

printing the selected number of limited edition stamps at the one location.

In accordance with yet another aspect of the present invention there is provided a limited edition stamp comprising:

a first indicia identifying the limited edition stamps as being a limited edition;

a second indicia which is not visible under normal viewing conditions for confirming that the limited edition stamp is a valid limited edition stamp.

In yet still another aspect of the present invention there is provided a sheet of limited edition stamps, each stamp comprising:

a first indicia identifying the limited edition stamps as being a limited edition;

a second indicia which is not visible under normal viewing conditions for confirming that the limited edition stamp is a valid limited edition stamp.

### BRIEF DESCRIPTION OF THE DRAWINGS

In the detailed description of the preferred embodiments of the invention presented below, reference is made to the accompanying drawings in which:

FIG. 1 is a plan view of a limited edition stamp made in accordance with the present invention;

FIG. 2 is a schematic drawing of a sheet of limited edition stamps of FIG. 1;

FIG. 3 is a schematic diagram of a system for printing limited edition stamps if FIGS. 1 and 2 from a plurality of different printers, the limited edition stamps each having a unique ID; and

FIGS. 4 and 5 together illustrate a flow chart of a system for selecting and printing limited edition stamps in accordance with the present invention.

### DETAILED DESCRIPTION OF THE INVENTION

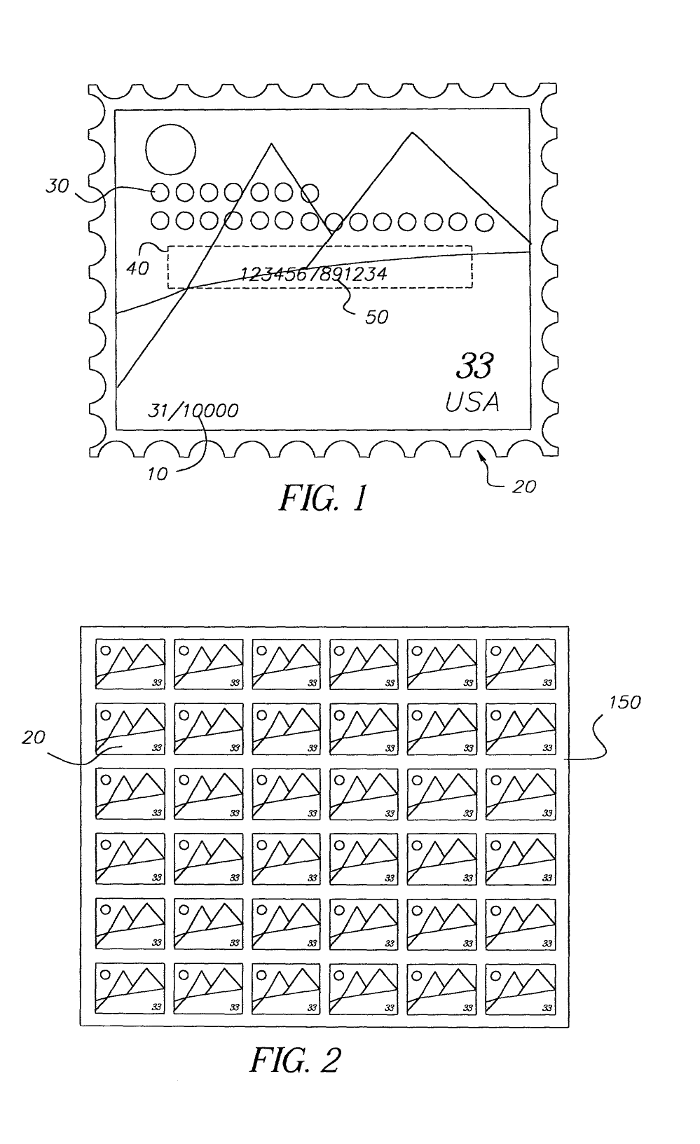

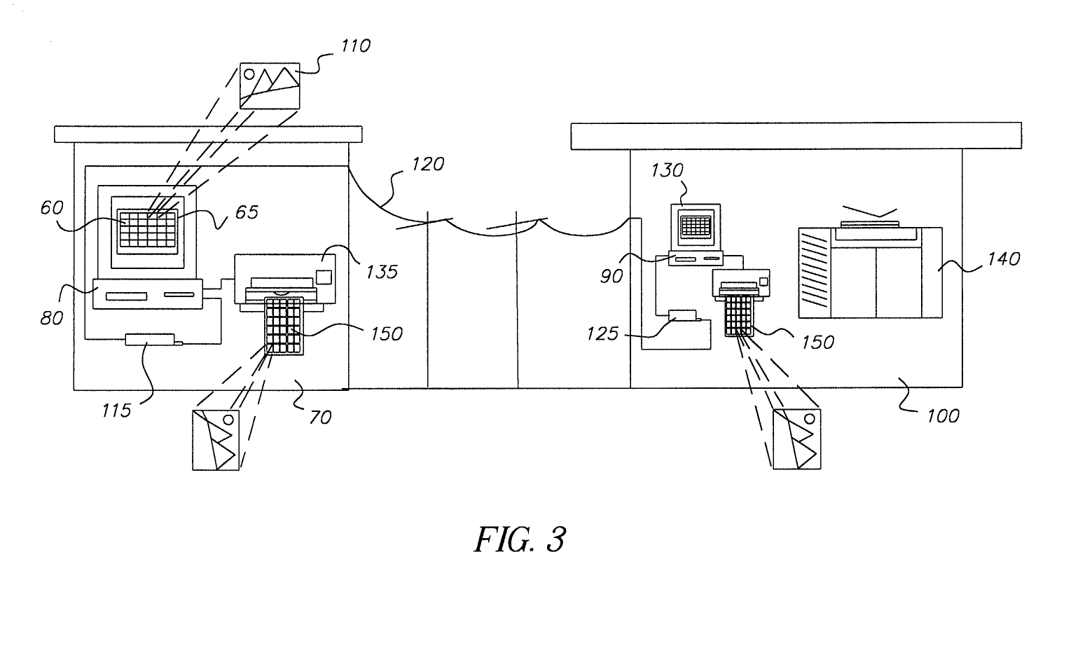

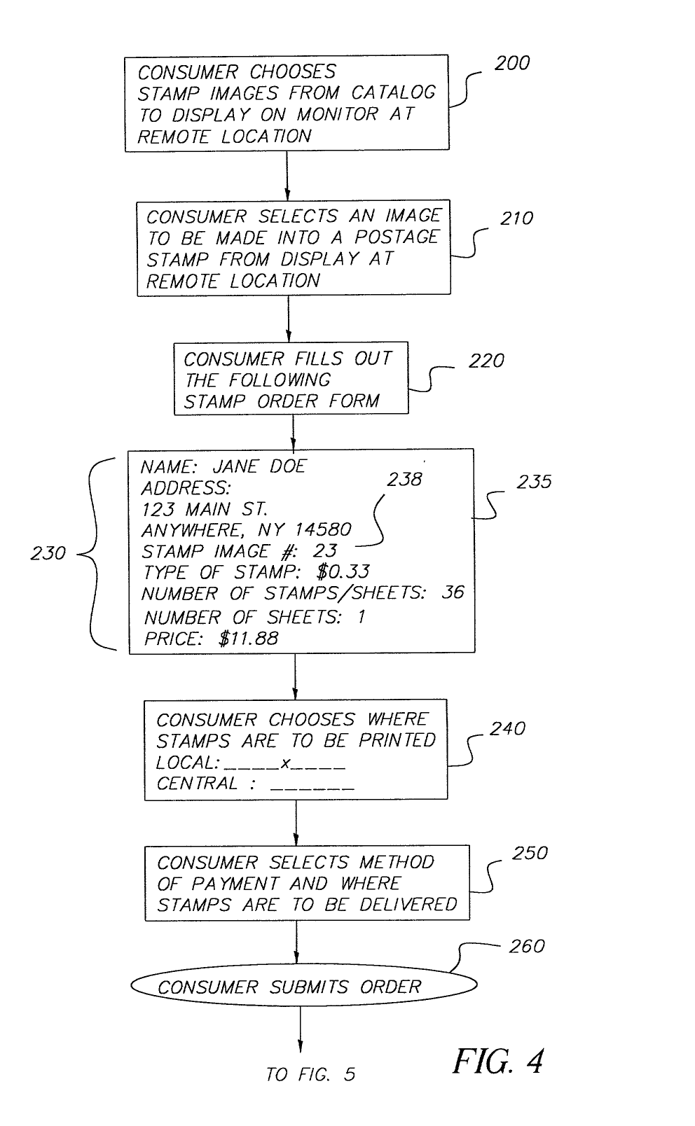

Now referring to FIG. 1 there is illustrated a plan view of a limited edition stamp 20 made in accordance with the present invention. The stamp 20 having a first visual indicia 10 in the form of a number identifying the stamp 20 as a limited edition stamp and a second invisible machine-readable indicia 30 which confirms the readable indicia 10. The second indicia 30 not capable of being scanned for reproduction as disclosed in U.S. Pat. No. 5,919,730 to Gasper et al, but is capable of being read under special viewing conditions for confirming that the stamp 20 is a limited edition stamp. The stamp has a third indicia area 40 having a unique identification number 50. The unique identification number 50 is used to identify the printer 135 shown in FIG. 3 (as further described herein) used to print the stamp 20 or sheet of stamps 150 shown in FIG. 2. The unique identification number 50 may be used to identify the remote location 70 shown in FIG. 3 where the stamps are to be printed. The unique identification number 50 may be used to identify both the printer used and it's location. The information printed in the third indicia area 40 may be eye readable or not visible to the eye under normal viewing conditions such as infrared or UV lights. In the embodiment illustrated the marking material is a fluid, and in particular an infrared or UV ink. However any suitable ink, dye and/or pigment may be used. Use of an infrared or UV light causes the indicia 30 or the unique identification number 50 to be invisible under normal viewing conditions. Eastman Chemical Company under the trade name N.I.R.F. (near-infrared fluorophore) inks sells appropriate suitable ink for placement of the information. The information printed in the third indicia area 40 may be encrypted as disclosed in U.S. Pat. Nos. 5,859,920; 5,905,819; and 5,835,639 which are hereby incorporated by reference. It is also disclosed in pending U.S. Ser. No. 08/848,112, filed Apr. 28, 1997, by Chris W. Honsinger et al, entitled METHOD FOR GENERATING AN IMPROVED CARRIER FOR USE IN AN IMAGE DATA EMBEDDING APPLICATION, which is hereby incorporated by reference. The information printed in the third indicia area 40 may be printed in a form that can be read or observed by a normal digital scanner.

Now referring to FIG. 3, there is illustrated in schematic form a system for printing limited edition stamps from a plurality of different printers at a plurality of locations. More particularly limited edition stamp images 60 are viewed on a monitor 65 at a remote location 70. The source of the images 60 can be image files stored in digital format on a server 90 at a central location 100. When an image 110 is selected at the remote location 70, image locator information and the location of where the image was selected is electronically transmitted as signals from a computer 80 at the remote location 70 to a server 90 at the central location 100. The signal is transmitted from the remote location's computer 80 connected via a modem 115 to a communication channel 120 such as the Internet. The signal is received via a modem 125 connected to a server 90 at the central location 100 where the information is received and stored in a memory 130. The transmitted information is comprised of, but not limited to, a unique identification number for the remote location, the image locator information, the number of stamps to be printed at the remote location, and a unique identification number for the printer 135 at the remote location 70. The image locator information identifies the digital file of the selected image 110 and where the file is located on the server 90 at the central location 100. The consumer who is purchasing the limited edition stamps has the option of designating the quantity of stamps to be printed and the location where the stamps are to be printed. For example the consumer may be making his or her stamp selection at their local post office, and request the stamps be printed at the central post office and be sent to his or her home address through the mail system. Likewise the consumer may request his or her stamp selection be printed at their local post office while they wait. In either case the digital image of the stamp is stored on the server 90,at the central location 100, and the requested image is downloaded to the appropriate printer at the requested location. If the stamps are to be printed at a remote location 70 where the quantity of stamps may be small, a printer such as a KODAK PS 8650 Color Printer or a KODAK Photo Printer 4700 may be used to produce a sheet of limited edition stamps 150. If the stamps are to be printed at the central location 100 where the quantity of stamps may be large, a printer such as a digital electrophotographic printer 140 such as an Indigo-E-1000 may be used to produce a sheet of limited edition stamps 150. In each case the location of where the stamps are printed and the printer used to print the stamps are uniquely identified and the unique identification number 50 (See FIG. 1) is printed on each stamp 20 on the sheet of stamps 150.

Now referring to FIG. 2, there is illustrated in schematic form a sheet 150 of limited edition stamps printing using the system described in FIG. 3. The number of limited edition stamps contained in the sheet 150 may vary in accordance with the capacity of the printers 135 or 140 used to print the stamps, the size of the stamps and the quantity of stamps ordered by the consumer.

Now referring back to FIG. 1, each stamp 20 in the sheet 150 shown in FIG. 2 is consecutively numbered with a first visual indicia 10 identifying each stamp with a number in the sequence. For example the stamp 20 is identified as stamp 31 out of the 10,000 stamps printed. Each stamp in the sheet 150 is printed with a second indicia 30 not shown in FIG. 2 not capable of being scanned for reproduction but visible under special viewing conditions for confirming that the stamp 20 is a limited edition stamp. The stamp 20 has a third indicia area 40 having a unique identification number 50 which designates both the printer used to produce the stamps and the location where the stamp was printed. The information printed in the third indicia area 40 may be eye readable or not visible to the eye under normal viewing conditions.

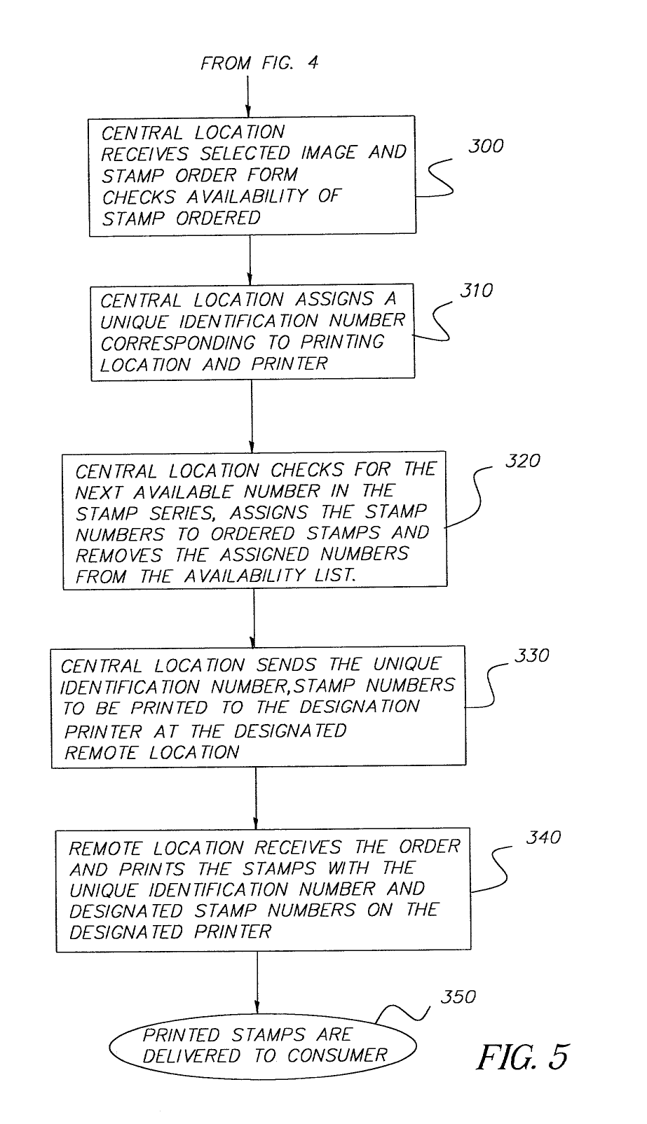

Now referring to both FIGS. 4 and 5 there is illustrated a flow chart of a system for selecting and printing limited edition stamps in accordance with the present invention. Referring to FIG. 4A consumer chooses a set of stamp images 60 from a catalog of stamp images displayed on the monitor 65 (See FIG. 2) at the remote location 70 as shown in step 200. The consumer selects a stamp image 110 from the set of stamp images 60 displayed as shown in step 210. After the desired stamp image 110 is selected, the consumer fills out step 220 the stamp order form 230 shown in step 235. The information on the stamp order form 230 is comprised of but not limited to the consumer's name, address, the stamp image number 238 shown in step 235. The consumer is shown the type of stamp and number of postage stamps to be printed on each sheet. The consumer indicates on the stamp order form 230 the number of sheets they wish to purchase. When the form 230 is completed, the form 230 shows the consumer the price of the order. The consumer then chooses where they would like the stamps printed, locally at the location where they are ordering the stamps or centrally as shown in step 240. The consumer selects the method of payment as shown in step 250 and submits the order as shown in step 260.

Now referring to FIG. 5 there is illustrated a continuation of the flow chart of FIG. 4. The consumer's submitted order from the remote location 70 comprised of the selected image 110 and the stamp order form 230 is received at the central location 100 as shown in step 300. The central location 100 checks on the availability of the selected stamp 110. The central location 100 assigns a unique identification number 50 corresponding to the printing locations 70, 100 and printers 135, 140 as shown in step 310. The central location 70 checks for the next available number 10 in the stamp series, assigns numbers to cover the number of stamps ordered and removes the assigned numbers from the availability list as shown in step 320. The central location 70 transmits the unique identification number 50, stamp numbers 10 and stamp image file 110 to the designated printer 135 at the designated remote location 70 as shown in step 330. The designated remote location 70 receives the unique identification number 50, stamp numbers 10 and stamp image file 110 as shown in step 340. The remote location 70 prints the sheet of stamps 150 which were selected with the unique identification number 50 and the assigned stamp numbers 10 on the printer 135 designated by the unique identification number 50. The printed sheet of stamps 150 is given to the consumer as shown in step 350.

The invention has been described in detail with particular reference to certain preferred embodiments thereof, but it will be understood that variations and modifications can be effected within the scope of the present invention, the present invention being defined by the following claims.

### PARTS LIST

10 first visual indicia

20 limited edition stamp

30 second invisible machine-readable indicia

31 stamp

40 third indicia area

50 unique identification number

60 limited edition stamp images

65 monitor

70 remote location

80 computer

90 server

100 central location

100 stamp image

115 modem

120 communication channel

125 modem

130 memory

135 printer

140 printer

150 sheet of stamps

200 step

210 step

220 step

230 step

235 step

238 stamp image number

240 step

250 step

260 step

300 step

310 step

320 step

330 step

340 step

350 step

What is claimed is

1. A method of printing limited edition stamps from a plurality of different printers, the limited edition stamps each having a unique ID, comprising the steps of:
allocating a selected number of said unique IDs to one of said plurality of different printers; and
printing said selected number of limited edition stamps with said unique IDs by said one printer.

2. A method according to claim 1 further comprising the steps of:
ordering said limited edition stamps at a first location; and
said printing occurring at a second location.

3. A method according to claim 2 further comprising the steps of:
said limited edition being picked up at said second location.

4. A method according to claim 1 further comprising the steps of:
ordering said limited edition stamps at a first location; and
forwarding said limited edition stamps to a second location.

5. A method according to claim 4 wherein said forwarding said limited edition stamps comprising mailing said limited edition stamps to designated location.

6. A method according to claim 5 wherein said designated location is the address of a purchaser of said limited edition stamps.

7. A method of printing limited edition stamps from a plurality of different locations, the limited edition stamps each having a unique ID, comprising the steps of:
allocating said unique IDs for a selected number of limited edition stamps to one location of said plurality of different locations; and
printing said selected number of limited edition stamps at said one location.

8. A method according to claim 7 further comprising the steps of:
ordering said limited edition stamps at a first location; and
said printing occurring at a second location.

9. A method according to claim 8 further comprising the steps of:
said limited edition being picked up at said second location.

10. A method according to claim 7 further comprising the steps of:
ordering said limited edition stamps at a first location; and
forwarding said limited edition stamps to a second location.

11. A method according to claim 10 wherein said forwarding said limited edition stamps comprising mailing said limited edition stamps to designated location.

12. A limited edition stamp comprising:
a first indicia identifying said limited edition stamps as being a limited edition;
a second indicia which is not visible under normal viewing conditions for confirming that said limited edition stamp is a valid limited edition stamp.

13. A limited edition stamp according to claim 12 wherein said first indicia comprises a unique ID.

14. A limited edition stamp according to claim 13 wherein said first indicia is visible.

15. A limited edition stamp according to claim 13 wherein said unique ID identifies that said limited edition stamp one out of a predetermined amount.

16. A limited edition stamp according to claim 12 said second indicia is not visible to the eye under normal viewing conditions.

17. A limited edition stamp according to claim 16 wherein said second indicia is not capable of being scanned.

18. A limited edition stamp according to claim 17 wherein said second indicia is made using an ink that can be seen when view under UV or infrared light.

19. A limited edition stamp according to claim 12 wherein a third indicia is provided for identifying the printer and/or location where said limited edition stamp was printed.

20. A limited edition stamp according to claim 19 wherein said third indicia is not visible to the eye under normal viewing conditions.

21. A limited edition stamp according to claim 20 wherein said third indicia is not capable of being scanned.

22. A limited edition stamp according to claim 21 wherein said third indicia is made using an ink that can be seen when view under UV or infrared light.

23. A sheet of limited edition stamps, each stamp comprising:
a first indicia identifying said limited edition stamps as being a limited edition;
a second indicia which is not visible under normal viewing conditions for confirming that said limited edition stamp is a valid limited edition stamp.

24. A sheet of limited edition stamps according to claim 23 wherein said first indicia comprises a unique ID.

25. A sheet of limited edition stamps according to claim 24 wherein said first indicia is visible.

26. A sheet of limited edition stamps according to claim 24 wherein said unique ID identifies that said limited edition stamp one out of a predetermined amount.

27. A sheet of limited edition stamps according to claim 23 said second indicia is not visible to the eye under normal viewing conditions.

28. A sheet of limited edition stamps according to claim 27 wherein said second indicia is not capable of being scanned.

29. A sheet of limited edition stamps according to claim 28 wherein said second indicia is made using an ink that can be seen when view under UV or infrared light.

30. A sheet of limited edition stamps according to claim 23 wherein a third indicia is provided for identifying the printer and/or location where said limited edition stamp was printed.

31. A sheet of limited edition stamps according to claim 30 wherein said third indicia is not visible to the eye under normal viewing conditions.

32. A sheet of limited edition stamps according to claim 31 wherein said third indicia is not capable of being scanned.

33. A sheet of limited edition stamps according to claim 32 wherein said third indicia is made using an ink that can be seen when view under UV or infrared light.
